(19) United States
(12) Patent Application Publication
(10) Pub. No.: US 2020/0342543 A1
(43) Pub. Date: Oct. 29, 2020

(54) System for Tracking Expenditures and Adjusting Payroll

(71) Applicants: Avinash Karnani, Brooklyn, NY (US); Paul Barnes-Hoggett, Brooklyn, NY (US)

(72) Inventors: Avinash Karnani, Brooklyn, NY (US); Paul Barnes-Hoggett, Brooklyn, NY (US)

(73) Assignee: This Is Alice, Inc., Brooklyn, NY (US)

(21) Appl. No.: 16/924,794

(22) Filed: Jul. 9, 2020

Related U.S. Application Data
(63) Continuation of application No. 15/857,132, filed on Dec. 28, 2017, now abandoned.

(51) Int. Cl. G06Q 40/00

(52) U.S. Cl. CPC G06Q 40/125; G06Q 40/123

(57) ABSTRACT

A tracking and payroll system uses a network-connected service-provider server executing first software on a processor from a non-transitory medium, providing services, a data repository coupled to the service-provider server, storing client profiles and data associated to specific clients, and interactive interfaces provided by the service provider server, through execution of the first software. An individual is registered as a client at the service-provider server, a profile is established for the client, the service is enabled by the client to track expenditures made by the client, expenditures tracked are processed to determine pre-tax eligibility for each expenditure, and an election amount is determined for the client, as an amount to be deducted by the client's employer for each pay period, to adjust tax withholding to agree with the client's pre-tax eligible regular expenditures.

### CROSS-REFERENCE TO RELATED DOCUMENTS

The present application is a continuation of co-pending application Ser. No. 15/857,132, filed Dec. 28, 2017. All disclosure of the parent application is incorporated herein at least by reference.

### BACKGROUND OF THE INVENTION

### 1. Field of the Invention

The present invention is in the technical area of systems for managing and tracking transactions and pertains more particularly to consolidating transactions that may be tax related.

### 2. Description of Related Art

It is well-known that certain expenses, both by businesses and by private individuals may be deductible from income in the process of determining tax liability at various levels of government. For example, within certain legal guidelines, expenses for public transportation, related to travel to and from place of employment, and to and from job assignments, may be deductible as part of the process to determine net income to be taxable. As another simple example, under certain conditions purchased meals and lodging may similarly be deductible. As a further example, in some instances, payments for dependent care expenses, medical expenses and medically related expenses may be subject to pre-tax treatment and/or may be deductible expenses under state, federal and local tax laws and regulations.

Many, if not most people are employed by private or government enterprises and have a certain level of eligible expenses related to that employment, and typically have other expenses that may qualify as pre-tax deductible. For most people, there is a clear opportunity, if an efficient and reliable system were available, to utilize pre-tax deductions to increase their net take-home pay (reduce payroll and income taxes) according to a clear knowledge of their eligible pre-tax expenditures. The present invention teaches a unique system for doing so.

### BRIEF SUMMARY OF THE INVENTION

In one embodiment of the invention a system is provided, comprising a network-connected service-provider server executing first software on a processor from a non-transitory medium, providing services, a data repository coupled to the service-provider server, storing client profiles and data associated to specific clients, and interactive interfaces provided by the service provider server, through execution of the first software. An individual is registered as a client at the service-provider server, a profile is established for the client, the service is enabled by the client to track expenditures made by the client, expenditures tracked are processed to determine pre-tax eligibility for each expenditure, and an election amount is determined for the client, as an amount to be deducted by the client's employer for each pay period, to adjust tax withholding to agree with the client's pre-tax eligible regular expenditures.

In one embodiment the client registers a credit card with the service-provider, enabling the service provider to communicate with a provider of the credit card, to access the client's expenditures made through the credit card as data to be used in the determination of pre-tax eligibility and the election amount. Also in one embodiment the client in addition registers one or more of payment media such as a debit card, an on-line banking site, and a third-party bill paying service, enabling the service provider to use transaction data from these additional sources in determining the election amount. IN one embodiment, once the election amount is determined, the election amount is communicated to the client, who interacts with the client's employer to enable the employer to use the election amount in determining the client's withholding amounts and net pay. And in one embodiment the client's employer is registered at the service provider, and, once the election amount is determined the election amount is communicated directly to the employer to be used in determining the client's withholding amounts and net pay.

In one embodiment of the invention an employer is registered at the service provider, and individual employees of the employer are registered as clients in interaction with the employer's payroll service. Also in one embodiment the service provider stores information regarding pre-tax eligibility of various categories of expenditures, the information is applied to determine eligibility, and in some cases communication is established with the client for further information in determining eligibility. And in one embodiment queries are sent to the client, and answers received, regarding individual ones of expenditures in the process of determining pre-tax eligibility for expenditures.

In another aspect of the invention a method is provided, comprising registering an individual at a service provider site through a network-connected server executing first software on a processor from a non-transitory medium, providing services, the server coupled to a data repository storing client profiles and data associated to specific clients, enabling the service provider by the client to track expenditures made by the client, filtering expenditures tracked to determine pre-tax eligibility for each expenditure, and determining an election amount for the client, as an amount to be deducted by the client's employer for each pay period, to adjust tax withholding to agree with the client's pre-tax eligible regular expenditures.

In one embodiment of the method the client registers a credit card with the service-provider, enabling the service provider to communicate with a provider of the credit card, to access the client's expenditures made through the credit card as data to be used in the determination of pre-tax eligibility and the election amount. Also in one embodiment the client in addition registers one or more of a debit card, an on-line banking site, and a third-party bill paying service, enabling the service provider to use transaction data from these additional sources in determining the election amount. Also in one embodiment, once the election amount is determined, the election amount is communicated to the client, who interacts with the client's employer to enable the employer to use the election amount in determining the client's withholding amounts and net pay. In one embodiment the client's employer is registered at the service provider, and, once the election amount is determined the election amount is communicated directly to the employer to be used in determining the client's withholding amounts and net pay. In one embodiment an employer is registered at the service provider, and individual employees of the employer are registered as clients in interaction with the employer's payroll service. In one embodiment the service provider stores information regarding pre-tax eligibility of various categories of expenditures, the information is applied to determine eligibility, and in some cases communication is established with the client for further information in determining eligibility. And in one embodiment queries are sent to the client, and answers received, regarding individual ones of expenditures in the process of determining pre-tax eligibility for expenditures.

### BRIEF DESCRIPTION OF THE SEVERAL VIEWS OF THE DRAWINGS

FIG. 1 is an architectural diagram in an embodiment of the present invention.

FIG. 2 is a diagram depicting set-up processes in an embodiment of the invention.

FIG. 3 is a diagram depicting processes in tracking and verifying eligibility in an embodiment of the invention.

### DETAILED DESCRIPTION OF THE INVENTION

In an embodiment of the present invention a service provider engages with individuals who may be employed by any of various companies, government agencies, or other enterprises, who pay the employees on a regular basis, determining tax liability and deducting from each paycheck for taxes, and periodically paying the deducted amounts to various tax authorities, particularly state and federal, and sometimes local government agencies.

Under tax law applicable at the time of filing the present application, it is common for employees to declare a number of dependents, and taxes deducted from each paycheck by a company, or by a third-party service operating in conjunction with the company, will be determined according to tables taking into account the number of dependents.

In addition to adjustment for dependents, there are a range of other expenditures regularly made by individuals that may qualify as pre-tax eligible expenditures, that is, expenditures that may be accounted for and deducted from gross pay, before arriving at a net amount for determining tax amount to be withheld and paid to government agencies. Dependent care may be eligible, transportation to and from work, certain educational expenses related to maintaining competency in a job or licensing requirements, as well as medical expenses and medically related expenses.

A significant problem for individuals is determining what expenditures are pre-tax eligible, and how to adjust tax withholding accordingly, or have their employers to do so, to avoid the expensive proposition of paying more tax than necessary with each pay period. It may be rather nice to get a refund at tax time, but one has to remember that that money is money that could have been available and used throughout the year, rather than being in the coffers of the government; moreover, certain pre-tax deductions are only available through employers' payroll.

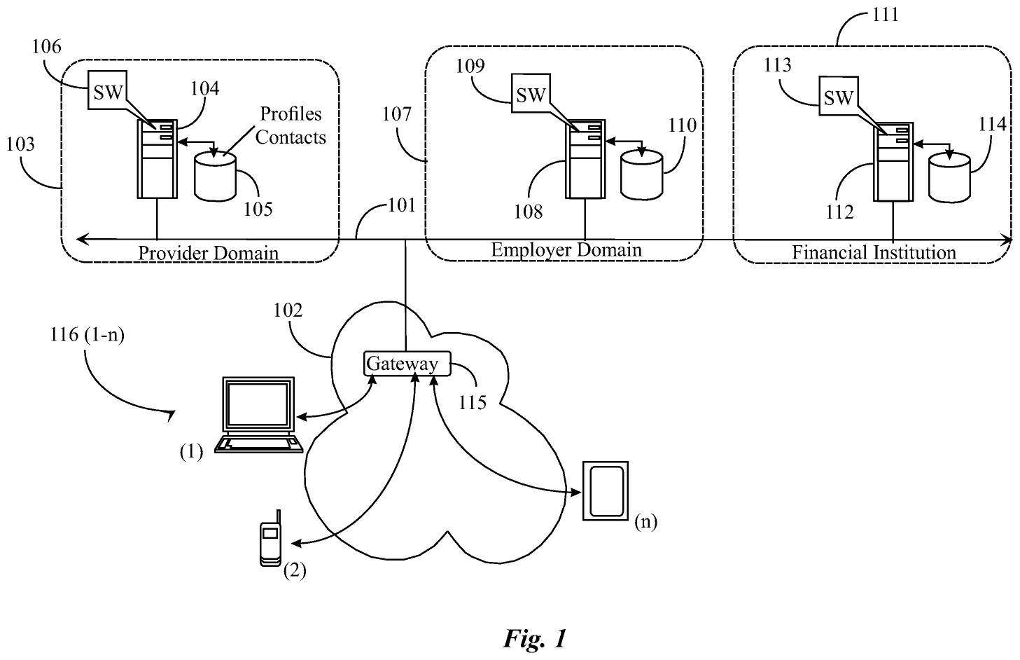

FIG. 1 is an architectural diagram illustrating network-connected entities, and communication between such entities in practicing an embodiment of the invention. Backbone 101 in FIG. 1 represents all of the networks and sub-networks that make up the well-known Internet network. Provider domain 103 represents a service provider that tracks expenses for a plurality of individuals who request the service, or for whom the service is requested by authority of another entity, such as an employer, and verifies and summarizes pre-tax eligible expenses for those individuals. The provider operates at least a server 104 executing software 106 on a processor of the server, and transacts with a data repository 105 where individual profiles and data are stored. SW 107 represents all computerized activity at the provider domain.

A plurality of individuals is assumed to operate network-connectable devices 116 (1-n), which include, as examples, a laptop computer (1), a smartphone (2), and a tablet device (n). These devices connect to Internet backbone 101 via a gateway 115, which represents a variety of ways by which individual devices may connect, such as through a cell network, a wi-fi network through a modem, an Internet service provider, and other know means for Internet connection.

An employer domain 107 is illustrated connected to the Internet backbone, and operating at least a server 108 executing SW 109 and accessing a data repository 110. In addition, a financial institution 111 is represented, connected to Internet backbone 101, operating at least one server 112 executing SW 113 and accessing a data repository 114.

The service provider 103 may operate more than one server, and operations may be widely distributed. In addition, the employer domain 107 is intended to represent a plurality of employers, who may employ individuals who may operate computerized appliances 116, and the employers may be assumed to provide payroll services for their employees through execution of SW 109, or through third-party payroll services, and may interact with establishments of the US Internal Revenue Service (IRS), and with state and local government entities as well. Financial institution 111 is meant to represent a variety of financial institutions, such as credit card organizations, banks, loan companies, and others.

Individuals may elect to enroll for the services of provider 103, and may do so by navigating on the Internet to a landing page provided by SW 106 executing on server 104, the SW providing one or more interactive interfaces for individuals to enroll, and to establish at least a username and password. Once enrolled other interactive interfaces guide the individual to identify his/her employer, and to provide information whereby the service provider may track the individual's expenditures through one or more credit cards, pre-paid debit cards, or debit cards.

Very few individuals manage their financial lives through cash payments. Most do so through exercise of credit card transactions, check payment, or on-line bill-pay systems, usually provided by a bank. In enrollment to service provider 103 the individual provides, through guidance and prompts, data and information enabling the service provider to access and use transaction data generated by that individual in paying for goods and services, thereby enabling the service provider to identify those transactions that may be eligible for pre-tax treatment. It should be noted that cash transactions are not excluded in the functionality and the service provided by this unique system, and such transactions may be included in circumstances where rationale and metadata surrounding such transactions has a means of being aggregated and processed by the system.

Considering provider domain 103, in various embodiments of the invention individuals may register to, and become clients of the service provider, and employers, such as an employer represented by employer domain 107, and financial institutions, such as one represented by Financial Institution domain 111, may also be registered as clients of the provider. Services provided to individuals, to financial institutions and to employers may vary.

In the case of individuals becoming clients of the host of provider domain 103, SW 106 in some embodiments provides a web site and interactive interfaces for registering an individual. A home page of the site may provide guidance and information about services provided, and advantages of membership, and also a procedure for registering as a client. Registration typically involves an individual navigating to the web site, and interacting with interfaces, such as choosing a username, and then a password, although there are other ways registration may occur. This sort of registration procedure is quite common in the art, and is not described in great detail here.

Once an individual has registered, in embodiments of the invention, the registration details and a profile are stored in data repository 105, where data associated with the person registering may also be stored and regularly updated.

In registration of an individual at the provider domain, in some embodiments the individual will be guided to provide identity of one or more employers, and may also be guided to disclose the registration to the employer, and may also be guided in some embodiments to seek cooperation of the employer in enabling services provided.

Another way individuals may be registered to Provider Domain 103 is by an employer 107 who registers, and provides identity of employees to be provided services by service provider 103. In this process, pre-registration may be done at and by the employer, who wishes their employees to be provided the services. This is an internal process requiring permission by each employee, and collection and verification of various data to be provided by the employer to the service provider, where profiles and data storage will be configured for each employee that wishes to be included in the service.

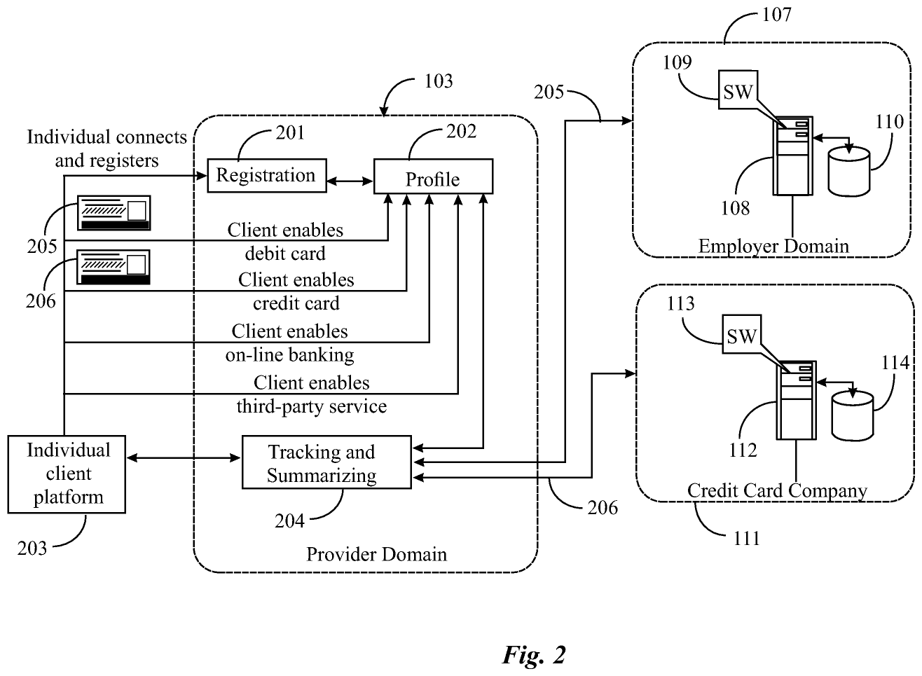

FIG. 2 is a diagram illustrating engagement of an individual, enablement of some services at provider 103, and processes of tracking and summarizing, in an embodiment of the invention. Provider domain 103, through execution of SW 106 (FIG. 1), provides registration functions indicated by block 201, whereby an individual operating network-connected platform 203 (one of devices 116(1-n) in FIG. 1), engages to register for services. In the process of registration, or post-registration, the client may enable a debit card 205, a credit card 206, and in some cases, may enabled the service provider to track her on-line banking or a third-party bill-pay service. The cards may be pre-paid, credit-based or may be a form of future payment media, including virtual cards and virtual currencies. The enablement is to allow the service provider to track, summarize and filter the individual's regular transactions, such as purchases of goods a and services, to determine if the expenditures may be pre-tax eligible, and to use such determinations in recommending adjustments to the individual's withholding at the employer, or the employer's payroll service, to maximize the individual's take-home pay without incurring a tax liability.

In the registration process 201 the client chooses a username and password, as previously indicated, and these become a part of the client's profile 202. The process of enabling a credit or debit card may be done in a variety of ways, to enable the service provider to periodically review the client's expenditures by means of such cards. This can be done in a manner that the service provider can copy expenditures, but may not, for example, make any expenditure not initiated by the client. This information comes to the service provider via communication along pathway 206.

In some cases, the client may pay many of her bills through on-line banking, or through a third-party bill management service. In this case the client may enable the service provider to track transactions on the on-line banking service of the client's bank. This is not shown in FIG. 2, but is similar to the communication with and data exchange done for tracking credit and debit card expenditures.

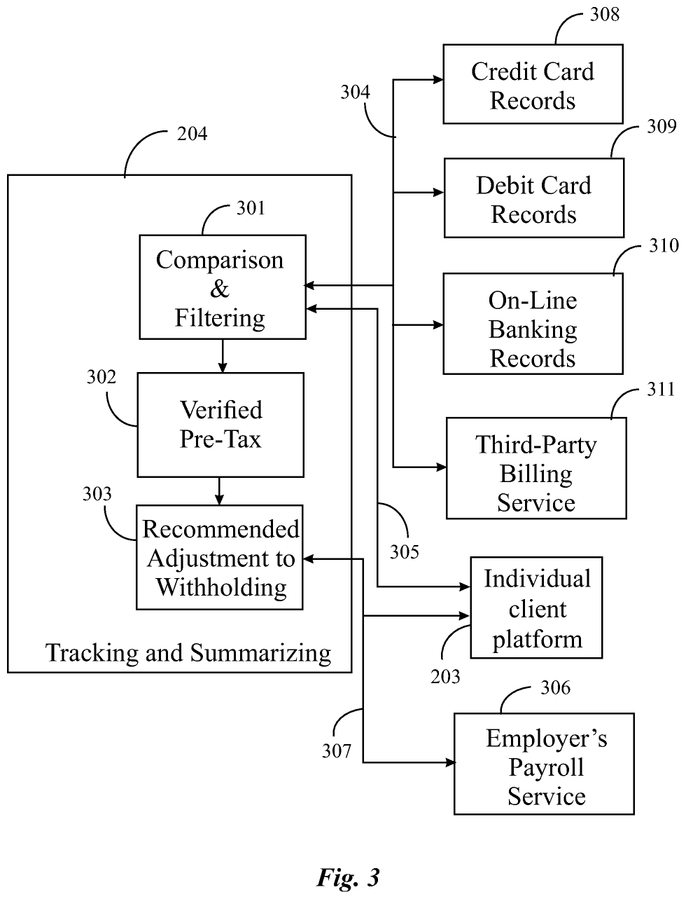

FIG. 3 is a diagram illustrating data capture, filtering, and processing, and subsequent communication of results for an individual client registered to the service provider. The tracking and summarizing function 204 of the service provider connects by paths 304 (Internet backbone 101) to data stores of transactions accomplished by a registered individual client. These data stores are at credit card companies, banks, financial institutions and the like, and may be credit card records 308, debit card records 309, on-line banking records 310, records at a third-party billing service 311, or other known transaction data records, including virtual and future payment media transaction data records. These data records may also include location information (latitude and longitude) for the transactions and the employee and other transaction related attributes captured in connection with the use of payment media. These records are accessed on a periodic basis and considered by comparison and filtering process 301, accomplished by a part of SW 106 at the service provider. The consideration may take many and diverse forms, such as name, description, amount, bank provided category, latitude and longitude of the transactions, latitude and longitude of the employee making the transaction, the month of the year, the day of the month, and day of week and many other attributes.

Service provider has pre-programmed knowledge of tax law and rules, and models for pre-tax expenditures for comparison and determination. As a part of the comparison and filtering process for the transaction records of an individual client, the service may communicate and query the client on occasion to make a determination. This communication may be by texting, email, online messaging service, or even by phone or mail.

Periodically the service determines a summary of verified pre-tax expenditures 302, typically by time period, for the subject client, and, depending on pay periods and other possible constraints operable at the client's employer, determines a recommended adjustment 303 to withholding for that client. This recommended adjustment may, in some embodiments, be communicated by path 307 to the individual client's platform, or may be accessed by the client through an interactive interface at the service's website, perhaps prompted by the service.

In some embodiments, the recommendation to the client periodically may be the end of the process, with the client responsible for communicating with her employer or employer's payroll provider, to make the requisite adjustment, so her withholding and take-home pay is in close alliance with her actual and allowable pre-tax expenditures. Additionally, in some embodiments, the client may utilize such recommendations during the preparation of their tax return to claim eligible deductions.

In some embodiments, where a cooperation exists between the service provider and the employer, the recommended adjustment may be transmitted to the employer's payroll service, and may be implemented in a more-or-less transparent fashion, and may also be revealed to the individual client.

In some embodiments, employers may elect to become clients of the service provider, perhaps before any employee might join, or perhaps after a few employees have done so and revealed the advantages to the employer. In this embodiment, the service provider and the employer may negotiate and cooperate electronically to register all or a portion of the employees of the employer with the service provider. In this process, the employer may provide an opportunity for each employee to approve the service on his or her behalf, as it is necessary to enable access to financial records for the employees, and some may not wish to participate, even though it may act as a raise in pay.

In the embodiment, wherein an employer registers and enables the service for employees, in some cases the employees will enable credit cards and other data sources directly at the service provider, as registrants, and in some embodiments this configuration may be done at the employer's site, perhaps aided by software provided by the service provider.

The service provided is an ongoing service to periodically adjust for changes in individual's circumstances, changes in credit cards and means of transacting, and so on. When an employee first becomes a registered client, and enables the service to collect and analyze transactions, an analysis is made, taking into account all pertinent variables and constraints, and an election amount is determined, which is an amount to be deducted by the employer for each payroll period. As time passes, each client's transactions are filtered for each pay period by performing a substantiation on each transaction to determine if transactions are pre-tax eligible. Alice communicates with the user, as described above, by messaging (email, SMS, other channels) to confirm certain transactions when appropriate, to maintain a high level of confidence regarding substantiation of transactions. After substantiation, eligibility for pre-tax treatment and compliance checks are passed, the service adds the substantiated amount up to the level of that period's election to the employee's net pay. As often as each election period, Alice makes recommendations on election amounts to employees with the aim of capturing all eligible pre-tax spending as well as minimizing unused deductions.

Examples and embodiments of the invention thus far in this specification reference pre-tax eligibility for expenditures, wherein the registrant's expenditures are analyzed, and a determination is made as to whether the tracked expenditures may be pre-tax eligible. There are known to be certain expenditures that are pre-tax eligible on a use-it-or-lose-it basis. An example is allowance for transit expenditures by the month, capped at for example, $255 at the time of filing this application. The nature of this allowance is that if you do not use the allowance by a certain date, you may lose it. In one embodiment of the invention the system tracks the registered user's expenditures for certain expenses, such as dependent care, transit and parking, and makes suggestions to the user as to whether the user should increase or decrease pre-tax deductions from compensation for such use cases, to reduce the possibility that unused deductions will be forfeited.

In one embodiment of the invention the system generates a single-purpose debit card functionality on anyone's general use payment card, to conform with the IRS rules for pre-tax deductions. The Virtual Single Purpose Debit Card is a traditional general-purpose debit or credit card that is rendered in functionality, through treatment at different points in transaction chronology, as a dual-purpose card. One aspect of such a card is that it can be used for all vendors, and the limited purpose, pre-tax aspect can only be used for internal revenue code pre-tax transit benefits up to $255/month.

So, in one aspect of the invention, a user, registered to as provider of this invention, may have a general-purpose card, for which transactions initiated by that card may be treated differently, dependent on a number of criteria, that may be applied during the process of processing and completing the transactions. One such criteria may be the type of expense and the vendor in the transaction, for example.

Currently this functionality requires the use of a dedicated limited-purpose debit card (a card that can only be used for qualified transit expensive because of the way the card is coded). If the user tries to use the limited-purpose card for a non-qualified expense the card will be rejected by the card network. The system of the invention creates the second (the limited-purpose card) virtually so that the user only needs to carry one card which instantiates both functions.

Further to the above, the examples and embodiments treat typically of expenditures that may be pre-tax eligible. Eligibility for pre-tax treatment under the tax laws is but one set of criteria to which the invention may be applied. In alternative embodiments, a user's expenditures may be tracked and analyzed as to whether the expenditures may be business-related expenditures, which may be reimbursed by employment agreement by an employer of the user. The criteria against which determination is different, but the procedure is much the same, in that the system tracks expenditures, analyzes the expenditures by a set of criteria, logs results, and deals with the employer to be sure reimbursement is made. There are similarly other criteria and uses for embodiments of the invention.

A person skilled in the art will understand that there are a relatively wide variety of ways that functions may be implemented as described above, and that the embodiments described are exemplary, and may in some cases be implemented somewhat differently of in a different order, while still falling within the scope of the invention.

1. A system, comprising:
a network-connected service-provider server executing first software on a processor from a non-transitory medium, providing services;
a data repository coupled to the service-provider server, storing client profiles and data associated to specific clients; and
interactive interfaces provided by the service provider server, through execution of the first software;
wherein an individual is registered as a client at the service-provider server, a profile is established for the client, the service is enabled by the client to track expenditures made by the client, expenditures tracked are processed to determine pre-tax eligibility for each expenditure, and an election amount is determined for the client, as an amount to be deducted by the client's employer for each pay period, to adjust tax withholding to agree with the client's pre-tax eligible regular expenditures.

2. The system of claim 1 wherein the client registers a credit card with the service-provider, enabling the service provider to communicate with a provider of the credit card, to access the client's expenditures made through the credit card as data to be used in the determination of pre-tax eligibility and the election amount.

3. The system of claim 2 wherein the client in addition registers one or more of payment media such as a debit card, an on-line banking site, and a third-party bill paying service, enabling the service provider to use transaction data from these additional sources in determining the election amount.

4. The system of claim 1 wherein, once the election amount is determined, the election amount is communicated to the client, who interacts with the client's employer to enable the employer to use the election amount in determining the client's withholding amounts and net pay.

5. The system of claim 1 wherein the client's employer is registered at the service provider, and, once the election amount is determined the election amount is communicated directly to the employer to be used in determining the client's withholding amounts and net pay.

6. The system of claim 1 wherein an employer is registered at the service provider, and individual employees of the employer are registered as clients in interaction with the employer's payroll service.

7. The system of claim 1 wherein the service provider stores information regarding pre-tax eligibility of various categories of expenditures, the information is applied to determine eligibility, and in some cases communication is established with the client for further information in determining eligibility.

8. The system of claim 7 wherein queries are sent to the client, and answers received, regarding individual ones of expenditures in the process of determining pre-tax eligibility for expenditures.

9. A method, comprising:
registering an individual at a service provider site through a network-connected server executing first software on a processor from a non-transitory medium, providing services, the server coupled to a data repository storing client profiles and data associated to specific clients;
enabling the service provider by the client to track expenditures made by the client;
filtering expenditures tracked to determine pre-tax eligibility for each expenditure; and
determining an election amount for the client, as an amount to be deducted by the client's employer for each pay period, to adjust tax withholding to agree with the client's pre-tax eligible regular expenditures.

10. The method of claim 9 wherein the client registers a credit card with the service-provider, enabling the service provider to communicate with a provider of the credit card, to access the client's expenditures made through the credit card as data to be used in the determination of pre-tax eligibility and the election amount.

11. The method of claim 10 wherein the client in addition registers one or more of a debit card, an on-line banking site, and a third-party bill paying service, enabling the service provider to use transaction data from these additional sources in determining the election amount.

12. The method of claim 9 wherein, once the election amount is determined, the election amount is communicated to the client, who interacts with the client's employer to enable the employer to use the election amount in determining the client's withholding amounts and net pay.

13. The method of claim 9 wherein the client's employer is registered at the service provider, and, once the election amount is determined the election amount is communicated directly to the employer to be used in determining the client's withholding amounts and net pay.

14. The method of claim 9 wherein an employer is registered at the service provider, and individual employees of the employer are registered as clients in interaction with the employer's payroll service.

15. The method of claim 9 wherein the service provider stores information regarding pre-tax eligibility of various categories of expenditures, the information is applied to determine eligibility, and in some cases communication is established with the client for further information in determining eligibility.

16. The method of claim 15 wherein queries are sent to the client, and answers received, regarding individual ones of expenditures in the process of determining pre-tax eligibility for expenditures.
